(19) United States
(12) Patent Application Publication
(10) Pub. No.: US 2013/0311257 A1
(43) Pub. Date: Nov. 21, 2013

(54) PRODUCT TRIAL USE TRANSACTION

(71) Applicants: Stephen George Svajian, Hermosa Beach, CA (US); Monica Ann McArthur, Los Angeles, CA (US); Timothy Ted Smalley-Wall, Culver City, CA (US)

(72) Inventors: Stephen George Svajian, Hermosa Beach, CA (US); Monica Ann McArthur, Los Angeles, CA (US); Timothy Ted Smalley-Wall, Culver City, CA (US)

(21) Appl. No.: 13/475,828

(22) Filed: May 18, 2012

(51) Int. Cl. G06Q 30/06; G06Q 30/02

(52) U.S. Cl. 705/14.15; 705/26.61

(57) ABSTRACT

For product trial use transactions, a distribution module receives a single specified subscription fee from a subscriber and receives a selection of a first product from a plurality of products. Purchase prices of the plurality of products are not uniform. The distribution module further provides the first product to the subscriber in response to receiving the single specified subscription fee and the selection of the first product. In addition, the detection module detects a return of the first product by a specified trial end date. A transaction module automatically transacts a sale of the first product to the subscriber after the specified trial end date if the first product is not received back from the subscriber by the specified trial end date.

### FIELD

The subject matter disclosed herein relates to product transactions and more particularly relates to a product trial use transaction.

### BACKGROUND

### Description of the Related Art

The online purchase of products is well known. However, many customers prefer to try products before making a purchase.

### BRIEF SUMMARY

A method for a product trial use transaction is disclosed. A distribution module receives a single specified subscription fee from a subscriber and receives a selection of a first product from a plurality of products. Purchase prices of the plurality of products are not uniform. The distribution module further provides the first product to the subscriber in response to receiving the single specified subscription fee and the selection of the first product. In addition, the detection module detects a return of the first product by a specified trial end date. A transaction module automatically transacts a sale of the first product to the subscriber after the specified trial end date if the first product is not received back from the subscriber by the specified trial end date. An apparatus and computer program product also perform the functions of the method.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of an online product trial use transaction system;

FIG. 2 is a drawing illustrating one embodiment of an order screen;

FIG. 3 is a schematic block diagram illustrating one embodiment of a computer;

FIG. 4 is a schematic block diagram illustrating one embodiment of a transaction apparatus; and

FIG. 5 is a schematic flow chart diagram illustrating one embodiment of a product trial use transaction method.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireline, optical fiber, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same computer program product via shared execution, transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the computer program product. The summed measurements of use units are periodically multiplied by unit costs and the resulting total computer program product service costs are alternatively sent to the customer and or indicated on a web site accessed by the customer which then remits payment to the service provider.

In one embodiment, the service provider requests payment directly from a customer account at a banking or financial institution. In another embodiment, if the service provider is also a customer of the customer that uses the computer program product, the payment owed to the service provider is reconciled to the payment owed by the service provider to minimize the transfer of payments.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

In one embodiment, software applications and version numbers are identified and compared to the list of software applications and version numbers that have been tested to work with the computer program product. Those software applications that are missing or that do not match the correct version will be upgraded with the correct version numbers. Program instructions that pass parameters from the computer program product to the software applications will be checked to ensure the parameter lists match the parameter lists required by the computer program product. Conversely parameters passed by the software applications to the computer program product will be checked to ensure the parameters match the parameters required by the computer program product. The client and server operating systems including the network operating systems will be identified and compared to the list of operating systems, version numbers and network software that have been tested to work with the computer program product. Those operating systems, version numbers and network software that do not match the list of tested operating systems and version numbers will be upgraded on the clients and servers to the required level.

In response to determining that the software where the computer program product is to be deployed, is at the correct version level that has been tested to work with the computer program product, the integration is completed by installing the computer program product on the clients and servers.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. The computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

The description of elements in each figure may refer to elements of proceeding figures. Like numbers refer to like elements in all figures, including alternate embodiments of like elements.

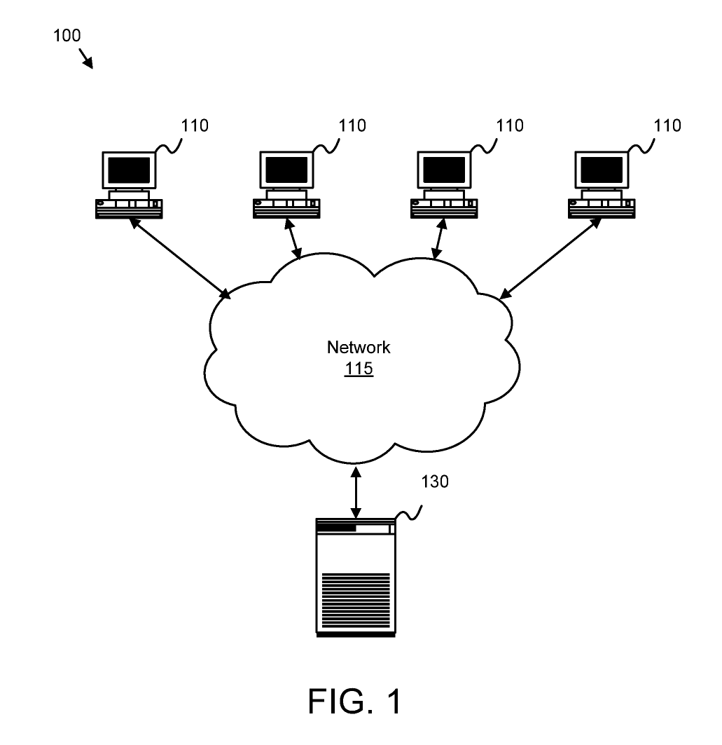

FIG. 1 is a schematic block diagram illustrating one embodiment of an online product trial use transaction system 100. The system 100 permits a subscriber to receive a product for trial use. In addition, the system 100 permits the subscriber to purchase the product at the end of the trial interval.

The system includes a plurality of subscriber computers 110. The subscriber computers 110 may be smart phones, cellular telephones, tablet computers, computer workstations, laptop computers, or the like. The subscriber computers 110 communicate through a network 115 with the least one server 130. The network 115 may be the Internet, a cellular telephone network, a local area network, a light area network, a proprietary network, or the like. Subscribers may use the subscriber computers 110 to review and request products for trial use.

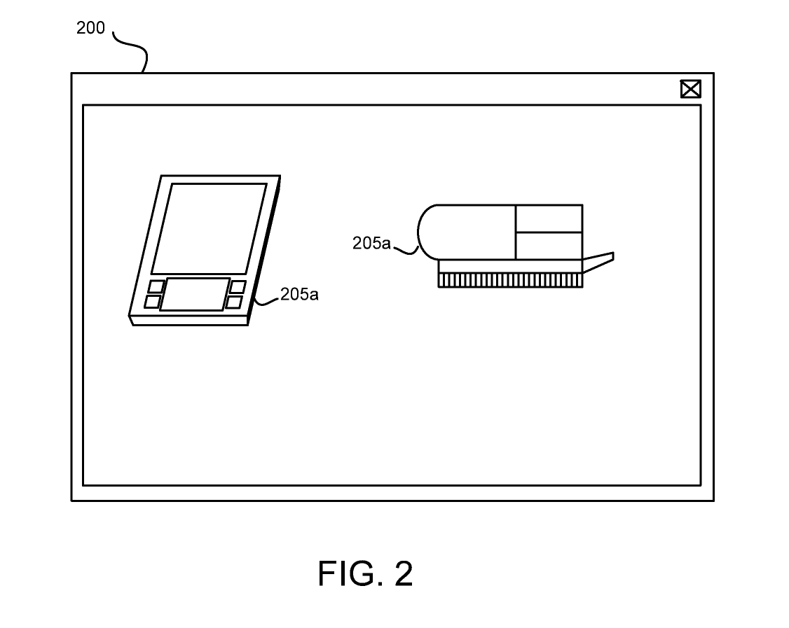

FIG. 2 is a drawing illustrating one embodiment of an order screen 200. The order screen 200 may be a web browser. The order screen 200 may be displayed on a subscriber computer 110. In the depicted embodiment, two products 205 are displayed although one skilled in the art will recognize that any number of products 205 may be employed. In one embodiment, the products 205 are refurbished products. In a certain embodiment, the products 205 are consumer electronics. Alternatively, the products 205 may be beauty products, apparel, sporting goods, vacation and recreation products, services, furniture, and the like. Each product 205 may be for trial use.

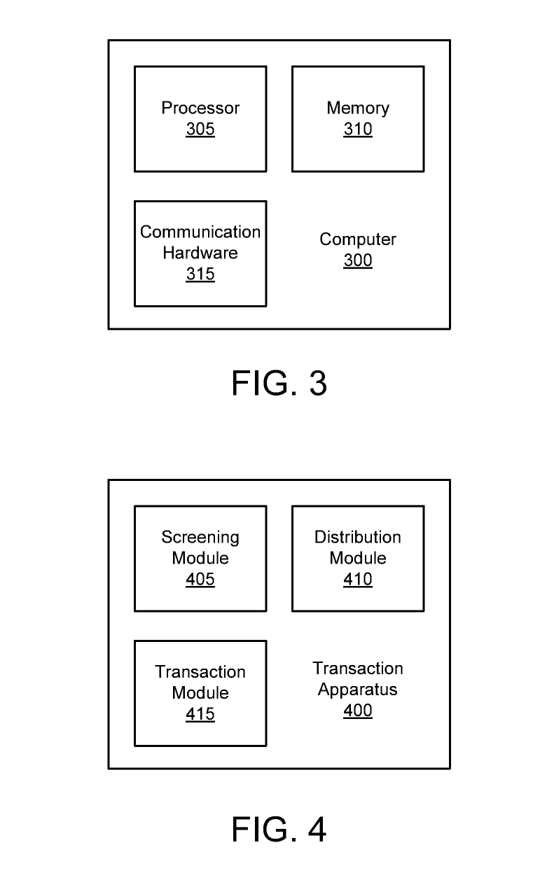

FIG. 3 is a schematic block diagram illustrating one embodiment of a computer 300. The computer 300 may be the server 130 of FIG. 1. Alternatively, the computer 300 may be the subscriber computer 110 FIG. 1. The computer 300 includes a processor 305, a memory 310, and communication hardware 315.

The memory 310 may be a semiconductor memory, a hard disk drive, and optical storage device, a micromechanical storage device, a holographic storage device, or combinations thereof. The memory 310 may store computer readable program code. The processor 305 may execute the computer readable program code. The communication hardware 315 may communicate with other devices and systems, such as the network 115.

FIG. 4 is a schematic block diagram illustrating one embodiment of a transaction apparatus 400. The apparatus 400 may be embodied in the computer 300 of FIG. 3. In particular, the apparatus 400 may be embodied in the server 130 FIG. 1. The apparatus 400 includes a screening module 405, a distribution module 410, and a transaction module 415. The screening module 405, distribution module 410, and transaction module 415 may be embodied in a computer readable storage medium storing computer readable program code executable by the processor 305.

In one embodiment, the screening module 405 screens the subscriber. The screening module 405 may employ the network 115 and the subscriber computer 110 to screen the subscriber.

In one embodiment, the distribution module 410 receives a single specified subscription fee from a subscriber and receives a selection of a first product 205a from a plurality of products 205 through the subscriber computer 110 and the network 115 at the server 130. The purchase prices of the plurality of products 205 are not uniform. The distribution module 410 provides the first product 205a to the subscriber in response to receiving the subscription fee and the selection of the first product 205a. The distribution module 410 further detects a return of the first product 205a by a specified trial end date.

The transaction module 415 automatically transacts a sale of the first product 205a to the subscriber after the specified trial end date if the first product 205a is not received from the subscriber.

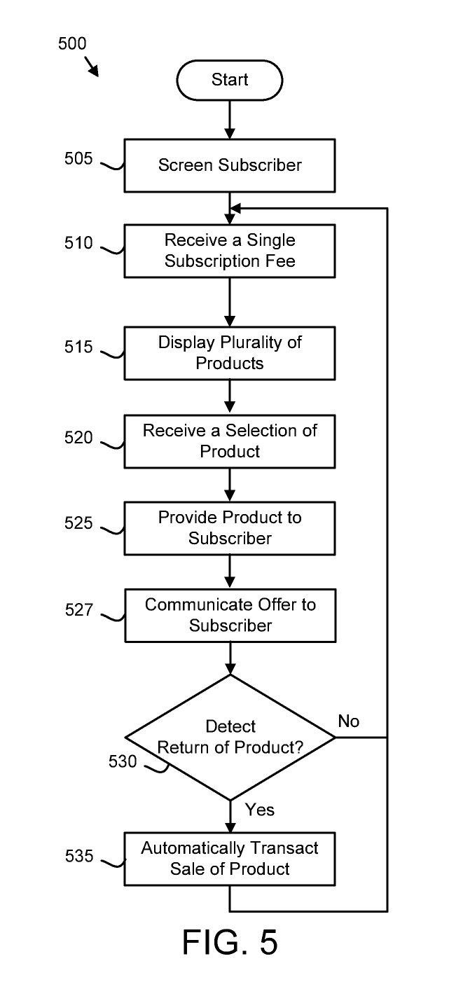

FIG. 5 is a schematic flow chart diagram illustrating one embodiment of a product trial use transaction method 500. The method 500 may perform the functions of the apparatus 400 in the system 100 of FIGS. 4 and 1 respectively. In one embodiment, the method 500 is performed by a computer readable storage medium. The computer readable storage medium may be the memory 310. The computer readable storage medium may store computer readable program code that is executed by the processor 305 to perform the method 500.

The method 500 starts, and in one embodiment, the screening module 405 screens 505 the subscriber. In one embodiment, the screening module 405 sets up an interview between the subscriber and the human screener. In addition, screening module 405 may arrange communication through the network 115 and the subscriber computer 110 between the subscriber and human screener.

In an alternate embodiment, the screening module 405 receives social media contact information from the subscriber. The screening module 405 may automatically review the social media contact information to screen the subscriber. The social media contact information may be an identifier, an email address, or the like. In one embodiment, the screening module 405 verifies access to a social media account of the subscriber to screen the subscriber, including an ability to post notices to the account.

The distribution module 410 may receive 510 a single specified subscription fee from the subscriber. In one embodiment, the single specified subscription fee does not vary depending on which product 205 is selected. In addition, the single specified subscription fee may not vary from month to month. The subscriber may pay the single specified subscription fee through the subscriber computer 110 and the network 115. The single specified subscription fee may be paid with a credit card transaction, a payment service transaction, or the like. In one embodiment, the single specified subscription fee is received monthly. In addition, the single specified subscription fee may be received 510 automatically.

In one embodiment, the subscriber may elect to not pay the single specified subscription fee a specified number of months each period. The period may be a quarter, six months, a year, two years, and the like.

The distribution module 410 may display 515 a plurality of products 205. The products 205 may be displayed in the order screen 200. The products 205 may be of a variety of product types. In addition each product 205 that is displayed may have a different price. The prices of the products 205 may not be uniform. In one embodiment, the prices of the products 205 may vary by an amount in the range of 10 to 100%. In a certain embodiment, the prices of the products 205 may vary in the range of 20 to 60%.

The distribution module 410 receives 520 a selection of the first product 205a from the plurality of products 205. In one embodiment, the subscriber may select any product 205 of the plurality of products 205 regardless of the price of the product 205.

The distribution module 410 provides 525 the first product 205a to the subscriber in response to receiving the single specified subscription fee and the selection of the first product. In one embodiment, the first product 205a is provided 525 by being shipped to the subscriber for arrival by a specified trial start date. The specified trial start date may be a first day of the month.

In one embodiment, the distribution module 410 communicates 527 an offer to the subscriber to purchase the first product 205a at a discounted price. The offer may be communicated 527 to the subscriber prior to a specified trial end date. The offer may be communicated through e-mail, text message, or the like.

The distribution module 410 detects 530 a return of the first product 205a by the specified trial end date. In one embodiment, the specified trial end date is the last day of the month. If the distribution module 410 detects 530 to return, the method 500 loops to receive 510 the single specified subscription fee.

In one embodiment, the transaction module 415 automatically transacts 535 a sale of the first product 205a to the subscriber after the specified trial end date if the first product 205a is not received from the subscriber by the specified trial end date and the method 500 loops to receive 510 the single specified subscription fee. In one embodiment, the sale is transacted specified price less the single specified subscription fee. The transaction module 415 may automatically charge a credit card, transaction account, or the like. The method 500 allows the subscriber to try products 205 before purchasing the product 205, increasing the likelihood of a satisfactory purchase.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for a product trial use transaction comprising:
receiving, by use of a processor, a single specified subscription fee from a subscriber;
receiving a selection of a first product from a plurality of products, wherein purchase prices of the plurality of products are not uniform;
providing the first product to the subscriber in response to receiving the single specified subscription fee and the selection of the first product;
detecting a return of the first product by a specified trail end date; and
automatically transacting a sale of the first product to the subscriber after the specified trial end date if the first product is not received from the subscriber by the specified trial end date.

2. The method of claim 1, further comprising screening the subscriber.

3. The method of claim 2, wherein the screening comprises a live interview with the subscriber.

4. The method of claim 2, wherein the screen comprises a social media review for the subscriber.

5. The method of claim 1, wherein the first product is provided by being shipped to the subscriber for arrival by a specified trial start date.

6. The method of claim 5, wherein the specified trial start date is a first day of a month and the specified trial end date is a last day of a month.

7. The method of claim 1, further comprising displaying a plurality of products for trial use.

8. The method of claim 1, wherein the method comprises communicating an offer to purchase the first product at a discounted price to the subscriber.

9. The method of claim 1, wherein the plurality of products are refurbished products.

10. The method of claim 1, wherein the plurality of products are consumer electronics.

11. The method of claim 1, wherein the sale is transacted for a specified price less the single specified subscription fee.

12. An apparatus comprising:
a computer readable storage medium storing computer readable program code executable by a processor, the computer readable program code comprising:
a distribution module receiving a single specified subscription fee from a subscriber and receiving a selection of a first product from a plurality of products, wherein purchase prices of the plurality of products are not uniform, providing the first product to the subscriber in response to receiving the single specified subscription fee and the selection of the first product, and detecting a return of the first product by a specified trial end date; and
a transaction module automatically transacting a sale of the first product to the subscriber after the specified trial end date if the first product is not received from the subscriber by the specified trial end date.

13. A computer program product for a product trial use transaction, the computer program product comprising:
a computer readable storage medium having computer readable program code embodied therein, the computer readable program code configured to:
receive a single specified subscription fee from a subscriber;
receive a selection of a first product from a plurality of products, wherein purchase prices of the plurality of products are not uniform;
provide the first product to the subscriber in response to receiving the single specified subscription fee and the selection of the first product;
detect a return of the first product by a specified trial end date; and
automatically transact a sale of the first product to the subscriber after the specified trial end date if the first product is not received from the subscriber by the specified trial end date.

14. The computer program product of claim 13, the computer readable program code further screening the subscriber.

15. The computer program product of claim 14, wherein the screening comprises a live interview with the subscriber.

16. The computer program product of claim 14, wherein the screening comprises a social media review the subscriber.

17. The computer program product of claim 13, wherein the first product is provided by being shipped to the subscriber for arrival by a specified trial start date.

18. The computer program product of claim 13, wherein the sale is transacted for a specified price less the specified subscription fee.
